(19) United States
(12) Patent Application Publication
(10) Pub. No.: US 2022/0219287 A1
(43) Pub. Date: Jul. 14, 2022

(54) METHOD FOR CUTTING POLYCRYSTALLINE SILICON ROD, METHOD FOR MANUFACTURING CUT ROD OF POLYCRYSTALLINE SILICON ROD, METHOD FOR MANUFACTURING NUGGET OF POLYCRYSTALLINE SILICON ROD, AND POLYCRYSTALLINE SILICON ROD CUTTING DEVICE

(71) Applicant: TOKUYAMA CORPORATION, Yamaguchi (JP)

(72) Inventors: Junya SAKAI, Yamaguchi (JP); Hiroyuki TASAKI, Yamaguchi (JP)

(21) Appl. No.: 17/609,877

(22) PCT Filed: Apr. 17, 2020
(86) PCT No.: PCT/JP2020/016832

§ 371 Date: Nov. 9, 2021

(30) Foreign Application Priority Data
Jun. 6, 2019 (JP) 2019-106232

(51) Int. Cl. B24B 55/02; B24B 27/06; B28D 1/00; B24B 55/06; B28D 7/02; B28D 1/12

(52) U.S. Cl. CPC B24B 55/02; B24B 27/0675; B24B 27/0658; B28D 1/121; B24B 55/06; B28D 7/02; B28D 1/003

(57) ABSTRACT

Provided is a method for preventing metal contamination during cutting of a polycrystalline silicon rod. A method for cutting a polycrystalline silicon rod (S) includes the step of cutting the polycrystalline silicon rod (S) by using a cutting tool (133). The step of cutting includes: delivering a liquid (L1) to a cutting position of the polycrystalline silicon rod (S) through a first nozzle (14); and delivering a liquid (L2) to a surface of the polycrystalline silicon rod (S) through a second nozzle (15).

### TECHNICAL FIELD

The present invention relates to a method for cutting a polycrystalline silicon rod, a method for manufacturing a cut rod of a polycrystalline silicon rod, a method for manufacturing a nugget of a polycrystalline silicon rod, and a polycrystalline silicon rod cutting device.

### BACKGROUND ART

A polycrystalline silicon rod, when manufactured by the Siemens process, is typically substantially cylindrical and elongated. In order to manufacture, by a pulling process or the like, a monocrystalline silicon ingot by using such a polycrystalline silicon rod as a raw material, the polycrystalline silicon rod needs to be cut to an appropriate length in some cases.

When a polycrystalline silicon rod is cut by using a typical rotating blade, a medium serving as a cooler and a lubricant, such as water and oil, is blown to a portion of the polycrystalline silicon rod while the portion is being cut. This is intended to prevent, for example, detachment of abrasive particles due to frictional heat generated between the blade and a material or attrition of the abrasive particles, and distortion of the blade. This process is known as a wet cutting process.

Problems connected with cutting of a polycrystalline silicon rod by using a blade in the wet cutting process or other cutting processes include contamination of the polycrystalline silicon rod not only due to powdery cutting chips of silicon but also due to dust generated from a metal component of the blade. The cause of this is explained as follows. The abrasive particles firmly fixed to the blade wear during cutting of the polycrystalline silicon rod. As a result, the metal component used as a binder for the abrasive particles comes into direct contact with the polycrystalline silicon rod and generates dust.

As an example of a solution to this problem, Patent Literature 1 proposes cutting a polycrystalline silicon rod by using an inner diameter blade which has abrasive particles firmly fixed to its inner circumferential part by electrodeposition, not by using an outer diameter blade which has the abrasive particles firmly fixed to its outer circumferential part with use of a metal bond. Patent Literature 2 proposes removing contaminants by subjecting, to a special etching process, the surface of the polycrystalline silicon rod which has undergone machining such as crushing.

### CITATION LIST

### Patent Literature

[Patent Literature 1]

Japanese Patent Application Publication Tokukai No. 2005-288891
[Patent Literature 2]

Japanese Patent Application Publication Tokukaihei No. 08-067510

### SUMMARY OF INVENTION

### Technical Problem

However, the cutting by using the inner diameter blade proposed in Patent Literature 1 may damage the blade under high load because a typical inner diameter blade has a thin edge. Further, even if the special etching process proposed in Patent Literature 2 is carried out, it may be impossible to completely remove contaminants from the surface of the polycrystalline silicon rod and thus impossible to sufficiently reduce impurity contamination of a monocrystalline silicon ingot. In addition, the etching process leads to an increased number of steps and increased costs in manufacture of a polycrystalline silicon rod.

An object of an aspect of the present invention is to provide a method for effectively preventing impurity contamination, in particular, metal contamination, during cutting of a polycrystalline silicon rod.

### Solution to Problem

In order to solve the above problem, a method, in accordance with an aspect of the present invention, for cutting a polycrystalline silicon rod includes the step of cutting the polycrystalline silicon rod by using a cutting tool, the step of cutting including: delivering a liquid to a cutting position of the polycrystalline silicon rod through a first nozzle; and delivering a liquid to a surface of the polycrystalline silicon rod through a second nozzle.

A method, in accordance with an aspect of the present invention, for manufacturing a cut rod of a polycrystalline silicon rod, includes the step of cutting the polycrystalline silicon rod by using a cutting tool, the step of cutting including: delivering a liquid to a cutting position of the polycrystalline silicon rod through a first nozzle; and delivering a liquid to a surface of the polycrystalline silicon rod through a second nozzle.

A polycrystalline silicon rod cutting device in accordance with an aspect of the present invention includes: a cutting tool for cutting a polycrystalline silicon rod; a first nozzle for delivering a liquid to a cutting position of the polycrystalline silicon rod; and a second nozzle for delivering a liquid to a surface of the polycrystalline silicon rod.

### Advantageous Effects of Invention

An aspect of the present invention makes it possible to effectively prevent impurity contamination, in particular, metal contamination, during cutting of a polycrystalline silicon rod.

### BRIEF DESCRIPTION OF DRAWINGS

FIG. 1 is a schematic view of a polycrystalline silicon rod cutting device in accordance with Embodiment 1 of the present invention.

FIG. 2 is a schematic view of aspects in which abrasive particles are firmly fixed in a diamond blade.

FIG. 3 is a schematic view of a polycrystalline silicon rod cutting device in accordance with Embodiment 2 of the present invention.

### DESCRIPTION OF EMBODIMENTS

### Embodiment 1

The following will describe an Embodiment of the present invention in detail with reference to drawings.

<Polycrystalline Silicon Rod Cutting Device>

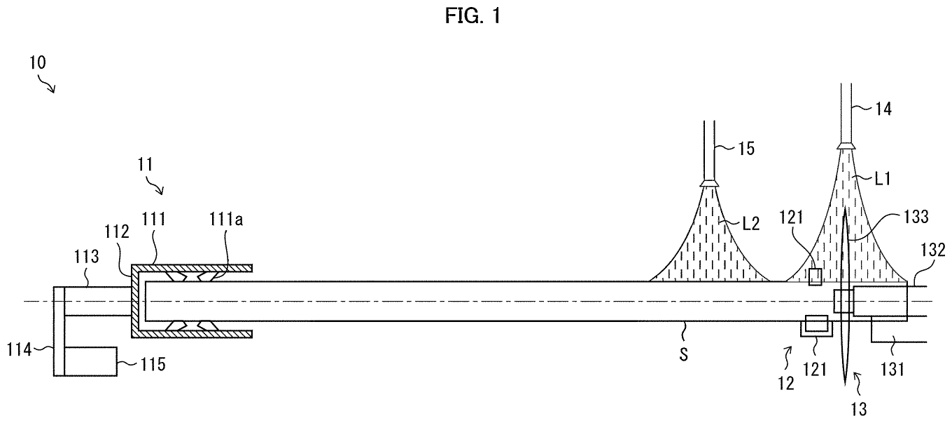

As illustrated in FIG. 1, a cutting device 10 for cutting a polycrystalline silicon rod S includes a proximal end-side support 11, a distal-side support 12, a cutting section 13, a first nozzle 14, and a second nozzle 15.

The polycrystalline silicon rod S to be cut in the present invention is prepared by, for example, the Siemens process. According to the Siemens process, a silicon core wire is set substantially upright in a bell jar reactor, and is heated by feeding electrical current and kept at approximately 1100° C. The silicon core wire has, for example, an inverted-U shape and has a diameter of several millimeters and a length of 1000 mm to 3000 mm. In the above condition, a silicon-containing compound, such as monosilane or trichlorosilane, is supplied to the reactor together with hydrogen gas, and caused to react together on a surface of the silicon core wire so that silicon is deposited on the surface of the silicon core wire. The polycrystalline silicon rod S is thus obtained. This polycrystalline silicon rod S is typically elongated and substantially cylindrical and has a diameter of 50 mm to 200 mm and a length of 1000 mm to 3000 mm.

The proximal end-side support 11 is a member for rotatably supporting one end portion (hereinafter, the one end is referred to as a proximal end) of the polycrystalline silicon rod S. The distal-side support 12 is a member for rotatably supporting another end portion (hereinafter, the other end is referred to as a distal end) of the polycrystalline silicon rod S.

The proximal end-side support 11 includes: a cylinder wall 111 having a cylindrical shape; chucks 111a protruding radially inward from the vicinity of the axially central part of the cylinder wall 111; a cylinder bottom wall 112 for covering a proximal end-side edge face of the cylinder wall 111; and a shaft member 113 extending from the cylinder bottom wall 112 in a direction away from the distal end and disposed coaxially with the cylinder wall 111. The proximal end-side support 11 is arranged to coaxially receive and support, in a cavity of the cylinder wall 111, a proximal end-side portion of the polycrystalline silicon rod S to be cut. The shaft member 113 is connected, via a power transmission member 114 such as a chain, to a rotation drive source 115 which drives the shaft member 113 so as to rotate the shaft member 113.

The distal-side support 12 includes a set of three rollers 121 which are used together and which are spaced 120° apart from each other along a circumference direction of the polycrystalline silicon rod S. The three rollers have a rotation axis parallel to the rotation axis of the cylinder wall 111 of the proximal end-side support 11.

The cutting section 13 is a member for cutting the polycrystalline silicon rod S at a position that is closer to the proximal end than the distal-side support 12 is. The cutting section 13 includes: a rotation drive source 131; a rotation shaft 132 connected to an output shaft of the rotation drive source 131; and a blade (a cutting tool) 133 attached to the rotation shaft 132. In the present embodiment, the blade 133 is an outer diameter diamond blade in which diamond abrasive particles are firmly fixed to an outer circumferential part of a substrate of the blade 133. However, the cutting tool of the present invention is not limited to this, and can be, for example, an inner diameter blade, a band saw, or a wire saw. Cutting the polycrystalline silicon rod S prepared by the Siemens process requires cutting, into two pieces, in a direction substantially perpendicular to an extending direction of the polycrystalline silicon rod S in several minutes, the polycrystalline silicon rod S having a diameter of 50 mm to 200 mm. The cutting tool of the present invention is therefore preferably an outer diameter blade in terms of productivity and facility costs. Although the blade 133 has dimensions that are not limited to any particular dimensions, the blade 133 has, for example, a diameter of 250 mm to 450 mm and a thickness of 1 mm to 3 mm.

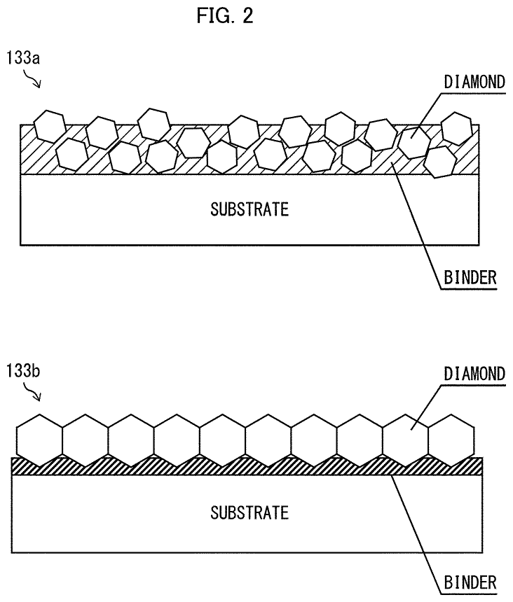

Examples of the type of the outer diameter diamond blade include a metal bond blade 133a and an electrodeposition blade 133b which are illustrated in FIG. 2. The metal bond blade 133a is prepared by mixing and packing together diamond abrasive particles and several kinds of metal powder which are to serve as a binder, and then sintering a resultant mixture. Examples of the metal powder to be used include cobalt, iron, steel, tungsten, bronze (Cu—Sn), and nickel.

The electrodeposition blade 133b is prepared, with use of a metal plating solution (electrolyte solution) in which diamond abrasive particles are suspended, by (i) causing metal to be deposited on a surface of the substrate by an electrolytic plating process and (ii) causing the diamond abrasive particles to be adsorbed and incorporated on a surface of the metal. A typical plated layer serving as the binder is based on nickel.

Besides these blades, usable examples of the type of the outer diameter diamond blade include a resin bond blade (not illustrated) in which diamond abrasive particles are firmly fixed by using a resin bond. The resin bond to be used is not limited to any particular bond, and can be a commercially available one.

In the electrodeposition blade 133b, since the abrasive particles are densely packed on the surface of the substrate, the binder has a small exposed area. Further, in the electrodeposition blade 133b, a metal component of the binder is limited primarily to nickel. This makes a contaminant coming from the blade 133 less likely to be scattered during cutting of the polycrystalline silicon rod S with use of the electrodeposition blade 133b, and also makes it possible to identify the type of the contaminant that is scattered. The blade 133 is therefore preferably the electrodeposition blade 133b in order to more effectively reduce contamination of the polycrystalline silicon rod S due to the contaminant coming from the blade 133.

Note that, unless otherwise specified herein, the phrase “contamination during cutting of the polycrystalline silicon rod” in the present invention refers to contamination through attachment to the surface of the polycrystalline silicon rod S and contamination through diffusion into the polycrystalline silicon rod S, and includes, in particular, metal contamination. The contamination through diffusion into the polycrystalline silicon rod S means contamination which remains even after a surface is dissolved with use of a chemical(s) and removed by several micrometers by dissolution using a chemical(s), from a cut rod of a polycrystalline silicon rod obtained by cutting the polycrystalline silicon rod S or a nugget obtained by crushing the cut rod.

Reference is made to FIG. 1 again. The first nozzle 14 is a member for delivering a liquid L1 to the cutting position of the polycrystalline silicon rod S. The first nozzle 14 is disposed above the blade 133 and the cutting position of the polycrystalline silicon rod S, and has an opening facing downward. The liquid L1 delivered through the first nozzle 14 serves not only as a lubricating medium for reducing friction between the blade 133 and the polycrystalline silicon rod S but also as a cooling medium for absorbing heat generated by the friction. In addition, the liquid L1 serves to remove abrasive particles and metal powder coming from the blade 133 and powdery cutting chips from the polycrystalline silicon rod S, when blown and delivered to the blade 133 and the cutting position of the polycrystalline silicon rod S during cutting of the polycrystalline silicon rod S.

The first nozzle 14 is connected to a pipe (not illustrated) through which the liquid L1 is supplied. This makes it possible to deliver the liquid L1 at any flow rate to the cutting position, during cutting of the polycrystalline silicon rod S.

The first nozzle 14 can have an end of any shape. Usable examples of the first nozzle 14 include, but not limited to, a flared nozzle. The opening at the end of the first nozzle 14 has a size which is not limited to any particular size. The opening preferably has a size which allows for delivery of the liquid enough for cutting depending on, for example, a size of the polycrystalline silicon rod S and an amount of the liquid to be delivered to the cutting position of the polycrystalline silicon rod S. Specifically, the opening preferably has a width in the range of approximately 0.5 mm to 15 mm.

The liquid L1 is of a type that is not limited to any particular type, provided that the liquid serves as a lubricating medium and a cooling medium. The liquid L1 can be, for example, water or oil, or can be a liquid in which an additive such as a cleaning ingredient is further added. In order to minimize contamination of the polycrystalline silicon rod S, the liquid L1 is preferably pure water, and particularly preferably pure water having a resistivity of not less than 1 MS/cm (mega-ohm centimeter).

The liquid L1 flows at a flow rate that is not limited to any particular flow rate. The flow rate can be a rate at which, when blown toward an upper surface of the polycrystalline silicon rod S through the first nozzle 14, the liquid L1 flows so as to spread, on the upper surface of the polycrystalline silicon rod S, over a region corresponding to an area of diameter× diameter, where the diameter is the diameter of the polycrystalline silicon rod S. For example, the flow rate can be 5 L/min to 20 L/min.

As described later, during cutting of the polycrystalline silicon rod S, the liquid L1 may be scattered together with the powdery cutting chips from the polycrystalline silicon rod S and contaminants coming from the blade 133. Scattered substances include one or more of (i) the liquid L1, (ii) the powdery cutting chips of the polycrystalline silicon rod S, and (iii) the contaminants coming from the blade 133. The contaminants coming from the blade 133 include, for example, some of the abrasive particles and the binder. Diligent study by the present inventors has revealed the following: a region where the liquid L1 flows on the surface of the polycrystalline silicon rod S extends for a width substantially the same as the diameter of the polycrystalline silicon rod S, independently of the flow rate of the liquid L1, but a region where the scattered substances adhere to the surface of the polycrystalline silicon rod S extends, in the extending direction of the polycrystalline silicon rod S, to a position which is three to five times the diameter of the polycrystalline silicon rod S away from the cutting position of the polycrystalline silicon rod S, depending on the flow rate of the liquid L1.

The second nozzle 15 is disposed so as to be closer to the proximal end than the first nozzle 14 is, and is a member for delivering a liquid L2 to be used for removal of the contaminants on the surface of the polycrystalline silicon rod S. The second nozzle 15 is disposed in a manner that allows the liquid L2 to be delivered to a region of the surface of the polycrystalline silicon rod S, the region extending, toward the proximal end, from the cutting position to a position which is at least not less than two times the diameter of the polycrystalline silicon rod S away from the cutting position, for example, a position 1000 mm away from the cutting position toward the proximal end. The second nozzle 15 has an opening facing downward. The liquid L2 delivered through the second nozzle 15 serves to remove, from the surface of the polycrystalline silicon rod S, the scattered substances scattered during cutting of the polycrystalline silicon rod S.

In order to more effectively remove the scattered substances generated during cutting of the polycrystalline silicon rod S, it is preferable to deliver the liquid L2 delivered through the second nozzle 15, to a region on the surface of the polycrystalline silicon rod S, the region extending to a position where the liquid L1 delivered through the first nozzle 14 does not flow but the scattered substances adhere.

The second nozzle 15 is connected to a pipe (not illustrated) through which the liquid L2 is supplied. The second nozzle 15 can have an end of any shape. Usable examples of the second nozzle 15 include, but not limited to, a flared nozzle, as with the first nozzle 14. Although the opening at the end of the second nozzle 15 has a size which is not limited to any particular size, the opening preferably has a size which allows delivery of the liquid enough for cutting, depending on, for example, a size of the polycrystalline silicon rod S and an amount of the liquid to be delivered to the cutting position of the polycrystalline silicon rod S. Specifically, the opening preferably has a width in the range of approximately 0.5 mm to 15 mm.

The liquid L2 is of a type not limited to any particular type, provided that the liquid can serve to remove the scattered substances generated during cutting of the polycrystalline silicon rod S. The liquid L2 can be, for example, pure water, or water containing an additive such as a cleaning ingredient. In order to minimize contamination of the polycrystalline silicon rod S, the liquid L2 is preferably pure water, and particularly preferably pure water having a resistivity of not less than 1 MΩcm.

The liquid L2 and the liquid L1 can be the same or different in composition. In order to simplify a piping arrangement for the liquids L1 and L2, the liquid L2 and the liquid L1 are preferably the same in composition.

The liquid L2 flows at a flow rate that is not limited to any particular flow rate. The flow rate may be a rate at which, when blown toward the upper surface of the polycrystalline silicon rod S through the second nozzle 15, the liquid L2 flows so as to spread, on the upper surface of the polycrystalline silicon rod S, over a region corresponding to an area of diameter× diameter, where the diameter is the diameter of the polycrystalline silicon rod S. For example, the flow rate of the liquid L2 is preferably larger than the flow rate of the liquid L1 in terms of more effectively removing impurities. Specifically, the flow rate of the liquid L2 can be 20 L/min to 40 L/min.

According to the present embodiment, the second nozzle 15 is disposed so as to be closer to the proximal end than the first nozzle 14 is and so as to be above the polycrystalline silicon rod S, and the number of the second nozzle 15 is one. However, the position and number of the second nozzle 15 are not limited to the above. The second nozzle 15 can be disposed at a position that is not limited to a particular position. For example, the second nozzle 15 can be disposed at a position where it is possible to deliver the liquid L2 to a region of the surface of the polycrystalline silicon rod S through the second nozzle 15, the region extending, toward at least one end (i.e., at least one of the proximal end and the distal end) of the polycrystalline silicon rod S in the extending direction of the polycrystalline silicon rod S, from the cutting position to a position which is at least not less than two times the diameter of the polycrystalline silicon rod S away from the cutting position. Accordingly, one or more second nozzle 15 can be disposed so as to be closer to the proximal end than the first nozzle 14 is, can be disposed so as to be closer to the distal end than the first nozzle 14 is, or can be disposed on both sides of the first nozzle 14.

The upper limit of the number of the second nozzles 15 is not limited to any particular number. The number of the second nozzles 15 is preferably not more than ten, in order to simplify an arrangement of the cutting device 10, or to reduce costs for the cutting work.

Further, the second nozzle 15 can be positionally fixed, or can be movable in the extending direction of the polycrystalline silicon rod S. In a case where the second nozzle 15 is movable, it is possible to deliver the liquid L2 to a wider region and thus more effectively remove contaminants than in a case where the second nozzle 15 is fixed.

According to the present embodiment, the second nozzle 15 is disposed at a position above the polycrystalline silicon rod S. However, the position of the second nozzle 15 is not limited to this, and can be disposed at a position lateral to or below the polycrystalline silicon rod S. The second nozzle 15 is preferably disposed above the polycrystalline silicon rod S in order that the liquid delivered through the second nozzle 15 can flow downward to fall off together with contaminants scattered during cutting of the polycrystalline silicon rod S.

<Method for Cutting Polycrystalline Silicon Rod>

When the polycrystalline silicon rod S is cut by using the blade 133, the rotation drive source 115 connected to the proximal end-side support 11 is rotated first. This causes, via the power transmission member 114, rotation of the shaft member 113, the cylinder bottom wall 112, and the cylinder wall 111 of the proximal end-side support 11, and thus causes rotation of the polycrystalline silicon rod S fixed to the cylinder wall 111 by the chucks 111a. While the polycrystalline silicon rod S rotates, the three rollers 121 of the distal-side support 12 also rotate. This allows the distal-side support 12 to support the polycrystalline silicon rod S without causing interference with the rotation of the polycrystalline silicon rod S.

In addition, the liquid L1 is delivered, through the first nozzle 14, to the blade 133 and to the cutting position of the polycrystalline silicon rod S, while the liquid L2 is delivered to the surface of the polycrystalline silicon rod S through the second nozzle 15.

Then, the blade 133 is pushed against the polycrystalline silicon rod S at the cutting position so as to be substantially perpendicular to the extending direction of the polycrystalline silicon rod S, while the rotation shaft 132 and the blade 133 are rotated in a direction opposite to the rotation direction of the polycrystalline silicon rod S by rotating the rotation drive source 131 of the cutting section 13. When the diamond abrasive particles of the blade 133 come in contact with the surface of the polycrystalline silicon rod S and grind the polycrystalline silicon rod S, the polycrystalline silicon rod S is cut from the outer circumference toward the center.

By appropriately repeating this cutting step at different positions in the extending direction of the polycrystalline silicon rod S, cut rods of the polycrystalline silicon rod S are manufactured. In other words, the method for manufacturing a cut rod of the polycrystalline silicon rod S includes the above cutting step. In addition, by carrying out a crushing step of crushing the cut rod by using, for example, a hammer or a crushing device, a nugget of the polycrystalline silicon rod S is manufactured. In other words, the method for manufacturing a nugget of the polycrystalline silicon rod S includes the above crushing step.

With such an arrangement, it is possible to remove contaminants from the cutting position of the polycrystalline silicon rod S by using the liquid L1 delivered through the first nozzle 14, the contaminants coming from the blade 133. Further, it is also possible to remove scattered substances from the surface of the polycrystalline silicon rod S by using the liquid L2 delivered through the second nozzle 15, the scattered substances being scattered during the cutting of the polycrystalline silicon rod S and including the contaminants coming from the blade 133. This makes it possible to effectively reduce contamination of the polycrystalline silicon rod S due to the contaminants coming from the blade 133.

The method in accordance with an embodiment of the present invention makes it possible to effectively reduce not only contaminants which are simply adhered to the surface of the polycrystalline silicon rod S but also metal contaminants which are difficult to remove by an etching process in which the surface of the polycrystalline silicon rod S is removed by several micrometers by dissolution.

More specifically, according to conventional methods, a scattered cutting liquid do not flow so as to fall off during the cutting, and thus adheres to the polycrystalline silicon rod and dries. The metal contaminants contained in the cutting liquid then diffuse on the surface of and into the subsurface portion of the polycrystalline silicon rod S. It may be therefore impossible to sufficiently reduce such metal contaminants even by etching. Contrarily, the method in accordance with an embodiment of the present invention makes it possible to more efficiently reduce the metal contaminants. The polycrystalline silicon rod S obtained by etching is therefore suitable for use in manufacture of a monocrystalline silicon ingot in which metal contaminants are sufficiently reduced.

The liquid delivered through the second nozzle 15 can be delivered to a region extending from the cutting position to a position which is at least not less than two times the diameter of the polycrystalline silicon rod S away from the cutting position. This makes it possible to deliver the liquid to a region where most of the scattered substances generated during the cutting of the polycrystalline silicon rod S reach, the region being on the surface of the polycrystalline silicon rod S. This consequently makes it possible to more effectively reduce contamination on the surface.

Further, the liquid is delivered through the second nozzle 15 from above the polycrystalline silicon rod S. This can cause the liquid including the contaminants scattered during the cutting of the polycrystalline silicon rod S to move on the surface of the polycrystalline silicon rod S and then flow downward so as to fall off the polycrystalline silicon rod S. This arrangement makes it possible to efficiently remove the liquid including the contaminants from the polycrystalline silicon rod.

The polycrystalline silicon rod S can be cut by using the electrodeposition blade 133b in which the diamond abrasive particles have been firmly fixed by electrolytic plating that primarily uses only nickel as a metal component, not by using a binder which contains a number of metal components. This makes the contaminants coming from the blade 133 less likely to be scattered during the cutting of the polycrystalline silicon rod S, and also makes it possible to identify the type of contaminants that are scattered. It is therefore possible to more effectively reduce contamination of the polycrystalline silicon rod S due to the contaminants coming from the blade 133. Further, since the polycrystalline silicon rod S rotates in a direction opposite to the rotation direction of the blade 133, it is possible to prevent the polycrystalline silicon rod from breaking at a position other than the cutting position in the cutting step.

### Embodiment 2

The following will describe another embodiment of the present invention. For convenience of description, the same reference sign is assigned to a member having the same function as the member described in the above embodiment, and the description of such a member is omitted.

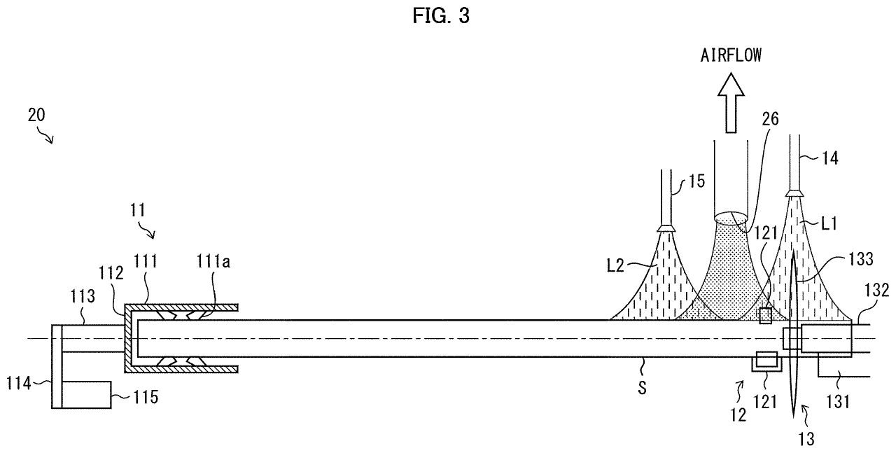

As illustrated in FIG. 3, a cutting device 20 has the same configuration as the cutting device 10 in accordance with Embodiment 1, except that the cutting device 20 further includes a suction opening 26 for sucking and removing an air including scattered substances having been scattered due to cutting of the polycrystalline silicon rod S.

The suction opening 26 is located at a position that is not limited to any particular position. For example, the suction opening 26 can be disposed between the first nozzle 14 and the second nozzle 15 in the extending direction of the polycrystalline silicon rod S. The suction opening 26 is preferably disposed in this way on a first nozzle 14 side of the second nozzle 15 in order to more effectively suck and remove the scattered substances generated during the cutting of the polycrystalline silicon rod S. Further, the suction opening 26 has a height that is not limited to any particular height. The suction opening 26 can be at substantially the same height as the polycrystalline silicon rod S. The suction opening 26 is preferably disposed at a position that does not interfere with an operation of a worker.

In a case where the blade 133 is an outer diameter blade, the suction opening 26 is preferably disposed at a position ahead of a portion of the blade 133 in a direction in which after the portion has come in contact with the polycrystalline silicon rod S, the portion moves by rotation. For example, when viewed from the proximal end of the polycrystalline silicon rod S, the suction opening 26 is preferably disposed on the left side of the polycrystalline silicon rod S in a case where the blade 133 rotates to the right. This arrangement makes it possible to effectively suck, through the suction opening 26, the scattered substances having been scattered from the blade 133, and thus makes it possible to more effectively reduce contamination of the polycrystalline silicon rod S with contaminants coming from the blade 133.

The suction opening 26 sucks the contaminants at a suction rate that is not limited to any particular rate, provided that the suction rate makes it possible to sufficiently suck the scattered substances generated during cutting of the polycrystalline silicon rod S. The suction opening 26 preferably sucks the air including the scattered substances at a suction rate of, for example, 10 m³/min to 30 m³/min.

More than one suction opening 26 can be provided so as to more effectively suck and remove the scattered substances generated during cutting of the polycrystalline silicon rod S.

Such an arrangement makes it possible to suck and remove scattered substances having been scattered due to cutting of the polycrystalline silicon rod S, before the scattered substances reach the surface of the polycrystalline silicon rod S. This makes it possible to reduce the amount of scattered substances which reach the surface of the polycrystalline silicon rod S, and thus to more effectively remove, by using the liquid L2 delivered through the second nozzle 15, the scattered substances from the surface of the polycrystalline silicon rod S.

Aspects of the present invention can also be expressed as follows:

In order to solve the above problem, a method, in accordance with an aspect of the present invention, for cutting a polycrystalline silicon rod, includes the step of cutting the polycrystalline silicon rod by using a cutting tool, the step of cutting including: delivering a liquid to a cutting position of the polycrystalline silicon rod through a first nozzle; and delivering a liquid to a surface of the polycrystalline silicon rod through a second nozzle.

Such an arrangement makes it possible to remove contaminants from the cutting position of the polycrystalline silicon rod by using the liquid delivered through the first nozzle, the contaminants coming from the cutting tool. In addition, the arrangement makes it possible to remove scattered substances from the surface of the polycrystalline silicon rod by using the liquid delivered through the second nozzle, the scattered substances being scattered during cutting of the polycrystalline silicon rod and including the contaminants coming from the cutting tool. This makes it possible to effectively reduce contamination of the polycrystalline silicon rod with the contaminants coming from the cutting tool.

According to a method, in accordance with an aspect of the present invention, for cutting a polycrystalline silicon rod, the liquid can be delivered to a region of the surface through the second nozzle, the region extending, toward at least one end in an extending direction of the polycrystalline silicon rod, from the cutting position to a position which is at least not less than two times a diameter of the polycrystalline silicon rod away from the cutting position.

Such an arrangement causes the liquid delivered through the second nozzle to be delivered to the region extending from the cutting position to the position which is at least not less than two times the diameter of the polycrystalline silicon rod away from the cutting position. This makes it possible to deliver the liquid to a region where most of the scattered substances scattered during the cutting of the polycrystalline silicon rod reach, the region being on the surface of the polycrystalline silicon. This consequently makes it possible to more effectively reduce contamination of the surface.

According to a method, in accordance with an aspect of the present invention, for cutting a polycrystalline silicon rod, the liquid can be delivered through the second nozzle from above the polycrystalline silicon rod so that the liquid delivered through the second nozzle moves on the surface of the polycrystalline silicon rod and then flows downward so as to fall off the polycrystalline silicon rod.

With this arrangement, the liquid is delivered from above the polycrystalline silicon rod through the second nozzle. Accordingly, the liquid including contaminants scattered during cutting of the polycrystalline silicon rod flows downward so as to fall off the polycrystalline silicon rod. This makes it possible to efficiently remove, from the polycrystalline silicon rod, the liquid including the contaminants.

According to a method, in accordance with an aspect of the present invention, for cutting a polycrystalline silicon rod, the step of cutting can further include sucking and removing an air including a scattered substance having been scattered due to the cutting.

This arrangement makes it possible to suck and remove the scattered substances having been scattered due to cutting of the polycrystalline silicon rod before the scattered substances reach the surface of the polycrystalline silicon rod. This makes it possible to reduce the amount of scattered substances which reach the surface of the polycrystalline silicon rod, and thus to more effectively remove, by using the liquid delivered through the second nozzle, the scattered substances from the surface of the polycrystalline silicon rod.

According to a method, in accordance with an aspect of the present invention, for cutting a polycrystalline silicon rod, the cutting tool is an outer diameter blade in which diamond abrasive particles are firmly fixed, and the step of cutting further includes rotating the polycrystalline silicon rod in a direction opposite to a rotation direction of the outer diameter blade.

In a case where the diamond abrasive particles are firmly fixed in the outer diameter blade, the polycrystalline silicon rod may be contaminated with contaminants coming from a binder (for example, a resin bond, a metal bond, or the like) used for such firm fixation. Consequently, this may adversely affect the quality of a monocrystalline silicon ingot manufactured from the polycrystalline silicon rod. Contrarily, the above-described arrangement makes it possible to reduce or prevent the adverse effect from these contaminants.

In a case of using, among other outer diameter blades, an outer diameter blade in which diamond abrasive particles are electrodeposited, the following effects are produced. A polycrystalline silicon rod is cut by using a blade in which diamond abrasive particles are firmly fixed by electrolytic plating that primarily uses only nickel as a metal component, but not by using a binder which contains a number of metal components. This makes contaminants coming from such a cutting tool less likely to be scattered during cutting of the polycrystalline silicon rod, and also makes it possible to identify the type of contaminants that are scattered. It is therefore possible to more effectively reduce contamination of the polycrystalline silicon rod with the contaminants coming from the cutting tool.

In addition, it is possible to prevent the polycrystalline silicon rod from breaking at a position other than the cutting position in the cutting step.

A method, in accordance with an aspect of the present invention, for manufacturing a cut rod of a polycrystalline silicon rod, includes the step of cutting the polycrystalline silicon rod by using a cutting tool, the step of cutting including: delivering a liquid to a cutting position of the polycrystalline silicon rod through a first nozzle; and delivering a liquid to a surface of the polycrystalline silicon rod through a second nozzle.

A method, in accordance with an aspect of the present invention, for manufacturing a nugget of a polycrystalline silicon rod, can include the step of crushing the cut rod obtained by the method for manufacturing the cut rod of the polycrystalline silicon rod.

A polycrystalline silicon rod cutting device in accordance with an aspect of the present invention includes: a cutting tool for cutting a polycrystalline silicon rod; a first nozzle for delivering a liquid to a cutting position of the polycrystalline silicon rod; and a second nozzle for delivering a liquid to a surface of the polycrystalline silicon rod.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following will describe examples of the present invention.

[Preparation of Cleaned Nugget]

### Example 1

A polycrystalline silicon rod (diameter: approximately 100 mm) was cut by using the cutting device 10 in accordance with Embodiment 1. The polycrystalline silicon S was cut with use of a diamond electrodeposition blade manufactured by Asahi Diamond Industrial Co., Ltd. During this cutting, the polycrystalline silicon S was rotated at approximately 50 rpm, while the blade 133 was rotated at approximately 2000 rpm in a direction opposite to a rotation direction of the polycrystalline silicon rod S. During the cutting, pure water was delivered as the liquid L1 at a flow rate of 10 L/min through the first nozzle 14 and pure water was delivered as the liquid L2 at a flow rate of 30 L/min through the second nozzle 15. A cut rod which is approximately 500 mm long was prepared by carrying out the cutting two times.

A nugget of the polycrystalline silicon rod S in accordance with Example 1 was prepared by crushing, with use of a tungsten carbide hammer, the above cut rod of the polycrystalline silicon rod until the maximum dimension of the nugget became approximately 100 mm. The nugget thus prepared was immersed in a bath of fluonitric acid (a mixture of nitric acid and hydrofluoric acid) so that a surface of the nugget was removed by several micrometers by dissolution. Subsequently, the nugget was washed with water and dried, so that a cleaned nugget was prepared.

### Example 2

A cleaned nugget of a polycrystalline silicon rod S in accordance with Example 2 was prepared as in Example 1, except that a metal bond blade was used instead of the diamond electrodeposition blade. The metal bond blade is a blade in which diamond abrasive particles are firmly fixed by using a metal bond.

### Comparative Example 1

A cleaned nugget of a polycrystalline silicon rod S in accordance with Comparative Example 1 was prepared as in Example 1, except that the polycrystalline silicon rod was cut without delivery of the liquid L2 through the second nozzle 15.

### Comparative Example 2

A cleaned nugget of a polycrystalline silicon rod S in accordance with Comparative Example 1 was prepared as in Example 2, except that the polycrystalline silicon rod was cut without delivery of the liquid L2 through the second nozzle 15.

### Reference Example

A cleaned nugget was prepared as a Reference Example, by: (i) immersing a nugget obtained by crushing a polycrystalline silicon rod S which had not been cut, as in Example 1, in a bath of fluonitric acid so that a surface of the nugget was removed by several micrometers by dissolution; and then (ii) washing with water and drying the nugget.

[Surface Heavy Metal Concentration]

The cleaned nuggets prepared in Examples 1 and 2 and Comparative Examples 1 and 2 were measured for respective surface heavy metal concentrations, by the method as follows.

First, each of the cleaned nuggets was immersed in a bath of fluonitric acid at room temperature, and a surface of the nugget was dissolved by a depth of approximately 20 micrometers, so that a resultant solution was obtained. Next, the mass of each of heavy metal components included in the resultant solution was measured by ICP-MS. Lastly, the surface heavy metal concentration was calculated by dividing the mass of the heavy metal component by the mass of the cleaned nugget (unit: parts per billion weight (ppbw)). Table 1 shows results of such calculations.

TABLE 1

| | | Surface heavy metal | | | |
|---|---|---|---|---|---|
| | | concentration (ppbw) | | | |
| | | Fe | Ni | Cr | Co |
| Example 1 | Electrodeposition blade | 0.08 | 0.02 | 0.07 | 0.01 |
| | used | | | | |
| Example 2 | Metal bond blade used | 0.09 | 0.02 | 0.08 | 0.01 |
| Comparative | Cutting by using | 0.12 | 2.7 | 0.07 | 0.01 |
| Example 1 | electrodeposition blade | | | | |
| | without delivery of | | | | |
| | liquid L2 | | | | |
| Comparative | Cutting by using metal | 0.11 | 0.92 | 1.6 | 0.84 |
| Example 2 | bond blade without | | | | |
| | delivery of liquid L2 | | | | |
| Reference | (Non-cut product) | 0.08 | 0.02 | 0.06 | 0.01 |
| Example | | | | | |

The heavy metal concentrations in Examples were lower than the heavy metal concentrations in Comparative Examples, and were substantially equal to those of the non-cut product in Reference Example.

### REFERENCE SIGNS LIST

10: Cutting device
13: Cutting section
14: First nozzle
15: Second nozzle
20: Cutting device
26: Suction opening
133: Blade
133b: Electrodeposition blade
L1: Liquid
L2: Liquid

1. A method for cutting a polycrystalline silicon rod comprising the step of cutting the polycrystalline silicon rod by using a cutting tool,
the step of cutting including:
delivering a liquid to a cutting position of the polycrystalline silicon rod through a first nozzle; and
delivering a liquid to a surface of the polycrystalline silicon rod through a second nozzle.

2. The method according to claim 1, wherein the liquid is delivered to a region of the surface through the second nozzle, the region extending, toward at least one end in an extending direction of the polycrystalline silicon rod, from the cutting position to a position which is at least not less than two times a diameter of the polycrystalline silicon rod away from the cutting position.

3. The method according to claim 1, wherein the liquid is delivered through the second nozzle from above the polycrystalline silicon rod so that the liquid delivered through the second nozzle moves on the surface of the polycrystalline silicon rod and then flows downward so as to fall off the polycrystalline silicon rod.

4. The method according to claim 1, wherein the step of cutting further includes sucking and removing an air including a scattered substance having been scattered due to the cutting.

5. The method according to claim 1, wherein:
the cutting tool is an outer diameter blade in which diamond abrasive particles are firmly fixed; and
the step of cutting further includes rotating the polycrystalline silicon rod in a direction opposite to a rotation direction of the outer diameter blade.

6. A method for manufacturing a cut rod of a polycrystalline silicon rod comprising the step of cutting the polycrystalline silicon rod by using a cutting tool, the step of cutting including:
delivering a liquid to a cutting position of the polycrystalline silicon rod through a first nozzle; and
delivering a liquid to a surface of the polycrystalline silicon rod through a second nozzle.

7. A method for manufacturing a nugget of a polycrystalline silicon rod comprising the step of crushing the cut rod obtained by the method according to claim 6.

8. A polycrystalline silicon rod cutting device comprising:
a cutting tool for cutting a polycrystalline silicon rod;
a first nozzle for delivering a liquid to a cutting position of the polycrystalline silicon rod; and
a second nozzle for delivering a liquid to a surface of the polycrystalline silicon rod.
